(19) United States
(12) Patent Application Publication
(10) Pub. No.: US 2004/0092316 A1
(43) Pub. Date: May 13, 2004

(54) Gaming machine with game medium straddling device

(75) Inventor: Hiroyuki Nagano, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: ARUZE CORP.

(21) Appl. No.: 10/695,863

(22) Filed: Oct. 30, 2003

(30) Foreign Application Priority Data
Oct. 30, 2002 (JP) 2002-316732

(51) Int. Cl. A63F 13/00

(52) U.S. Cl. 463/43

(57) ABSTRACT

The coin straddling device CS of the slot machine 1 is constructed from the coin straddling member 57 which is rotatably supported in the retaining bracket 56 and has a pair of brackets 572 outwardly extended from both side walls of the tubular guiding part 571, and the magnetic solenoid 59. When the magnetic solenoid 59 is not magnetized, coins inserted from the coin insertion slot 51 are guided to the hopper 25 through the coin guide path 55A, the duct constructed from the inner walls of the tubular guiding part 571 and the opening 24A of the coin guide 24. And When the magnetic solenoid 59 is magnetized, the coin straddling member 57 is rotated and the coins inserted from the coin insertion slot 51 are guided to the coin tray 30 through the coin guide path 55A, the coin guide path constructed from the inner walls of the brackets 572 and the inner wall of the retaining bracket 56, and the coin guide 31.

### CROSS-REFERENCE TO THE RELATED APPLICATION(S)

This application is based upon and claims a priority from the prior Japanese Patent Application No. 2002-316732 filed on Oct. 30, 2002, the entire contents of which are incorporated herein by reference.

### BACKGROUND OF THE INVENTION

1. Field of the Invention

The present invention relates to a gaming machine with a game medium straddling device, in particular to a gaming machine with a game medium straddling device that the construction thereof can be very simplified and game medium straddling operation can be certainly done.

2. Description of Related Art

Generally speaking, in gaming machines such as a slot machine and a video porker gaming machine installed in a casino or a penny arcade, time consumed for one game is very short and plural game media such as coins can be used for one game. Therefore, it is necessary for a player to insert the game medium frequently in the gaming machine.

However, it is very troublesome matter for a player to repeat the above game medium inserting operation every one game and concentration of a player against the game is ceased every inserting operation of the game medium. Therefore, this is undesirable for a player.

In order to dissolve the above problems, plural game media such as coins can be inserted beforehand in the gaming machine and the gaming machine has the so-called credit function that game media to be paid out for a player according to a game result can be stored in the gaming machine.

Here, the number of the game media capable for storing in the gaming machine is not unlimited but is limited to a predetermined number. Thus, when game media in excess of the predetermined number are inserted in the gaming machine, such game media are exhausted to a pay out tray through a pay out chute without storing in the gaming machine.

Similarly, when coins or medals not able to use for the gaming machine are falsely inserted in the gaming machine, such coins or medals are directly exhausted to the pay out tray through the pay out chute without storing therein.

Taking the above situation into consideration, a straddling device for straddling operation to store the inserted game media in the gaming machine or to directly exhaust them out of the gaming machine is installed in many gaming machines, as shown in Japanese Unexamined Publication No. 2002-177445.

However, such straddling device has a very complex construction with necessarily many parts, in order to surely straddle coins or medals.

Due to the fact that the straddling device has many parts because of the complex construction, many assembling steps are necessary to assemble the straddling device. Thus, cost in parts and personal expenses for assembling become very high. As a result, it is difficult to reduce cost in the straddling device.

Further, in the main part controlling such straddling operation of coins or medals in the above straddling device, there are two openings, one of which is opened for one guiding part and the other of which is opened for the other guiding part, respectively, in order to straddle coins or medals. Therefore, in a case that coins or medals jumps up and down near the openings due to any causes, there is fear that coins or medals are mistakenly straddled to the guiding part which is different from the guiding part that coins or medals should be inherently straddled.

Thus, in the above straddling device, even if such situation occurs, it is necessary to arrange at least two sensors to confirm that coins or medals are straddled to which of guiding parts. As a result, cost necessary for the sensors causes an increase in cost of the straddling device.

### SUMMARY OF THE INVENTION

The present invention is accomplished to dissolve the above-mentioned problems in the related art and it is an object of the present invention to provide a gaming machine having a lower-cost straddling device than the prior straddling device.

Further, it is an object of the present invention to provide a gaming machine having a straddling device with a simple construction. Accordingly, straddling operation of coins or medals can be surely done.

According to one aspect of the present invention, it is provided a gaming machine as follows.

Namely, it is provided a gaming machine including:

a game medium insertion part through which a game medium is inserted in a cabinet, the game medium insertion part being provided in the cabinet;

a game medium accumulating part for accumulating the game medium inserted from the game medium insertion part in the cabinet; and

a straddling device for straddling the game medium inserted from the game medium insertion part to one of the game medium accumulating part and a game medium paying out part;

wherein the straddling device includes;

a straddling member rotatably supported in the cabinet, the straddling member having a first guiding part through which the game medium is guided to the game medium accumulating part and a second guiding part through which the game medium is guided to the game medium paying out part; and

a driving device for rotating the straddling member;

wherein the straddling member straddles the game medium to the game medium accumulating part through the first guiding part or to the game medium paying out part through the second guiding part, according to rotational state of the straddling member rotated by the driving device.

In the above gaming machine, since the straddling device includes the straddling member rotatably supported in the cabinet, the straddling member having the first guiding part through which the game medium is guided to the game medium accumulating part and the second guiding part through which the game medium is guided to the game medium paying out part, and the driving device for rotating the straddling member, and the straddling member straddles the game medium to the game medium accumulating part through the first guiding part or to the game medium paying out part through the second guiding part, according to rotational state of the straddling member rotated by the driving device, the game medium inserted from the game medium insertion part can be surely guided to the game medium accumulating part or to the game medium paying out part by simple action of only rotating the straddling member through the driving device.

Here, straddling operation by the straddling member in the straddling device is basically defined as follows. That is, the straddling member can swing because of rotation thereof when being driven by the driving devices Thus, swinging state of the straddling member changes, as a result, the straddling member can select one of the game medium accumulating part and the game medium paying out part to which the game medium is to be guided, according to the swinging state thereof.

And the straddling device is constructed from the rotatable straddling member and the driving device for rotating the straddling member, thus structure of the straddling device can be simply constructed.

Further, since the number of parts for constructing the straddling device can be reduced, it can realize the low-cost straddling device, and the straddling device scarcely gets out of order, maintenance of the straddling device can be easily conducted.

Furthermore, according to rotational state of the straddling member, the game medium can be guided to the game medium accumulating part through the first guiding part or to the game medium paying out part through the second guiding part, thereby it can prevent the game medium from jumping up and down. As a result, it can omit sensors for detecting places where the game medium is to be sent, differently from prior gaming machines.

And, according to another aspect of the present invention, it is provided a gaming machine as follows.

Namely, it is provided a gaming machine including:

a game medium insertion part through which a game medium is inserted in a cabinet, the game medium insertion part being provided in the cabinet;

a game medium accumulating part for accumulating the game medium inserted from the game medium insertion part in the cabinet;

a straddling device for straddling the game medium inserted from the game medium insertion part to one of the game medium accumulating part and a game medium paying out part;

a first guide path for guiding the game medium inserted from the game medium insertion part to the straddling device;

a second guide path for guiding the game medium to the game medium accumulating part from the straddling device; and

a third guide path for guiding the game medium to the game medium paying out part from the straddling device;

wherein the straddling device includes;

a straddling member rotatably supported in the cabinet, the straddling member having a tubular guiding part for guiding the game medium to the game medium accumulating part; and

a driving device for rotating the straddling member;

wherein the driving device rotates the straddling member between a first rotational position and a second rotational position,

wherein the tubular guiding part of the straddling member opposes to an opening of the second guide path and closes an opening of the third guide path while the straddling member is retained to the first rotational position by the driving device, thereby the game medium is straddled to the game medium accumulating part through the first guide path, the tubular guiding part and the second guide path, and

wherein the tubular guiding part of the straddling member closes the opening of the second guide path while the straddling member is retained to the second rotational position by the driving device, whereby the game medium is straddled to the game medium paying out part through the first guide path, an outer wall of the tubular guiding part and the third guide path.

In the above gaming machine, the straddling device includes the straddling member rotatably supported in the cabinet, the straddling member having the tubular guiding part through which the game medium is guided to the game medium accumulating part and the driving device for rotating the straddling member between the first rotational position and the second rotational position, and the tubular guiding part of straddling member opposes the opening of the second guide path and closes the opening of the third guide path while the straddling member is retained to the first rotational position by the driving device, thereby the game medium is straddled to the game medium accumulating part through the first guide path, the tubular guiding part and the second guide path, and the tubular guiding part closes the opening of the second guide path while the straddling member is retained to the second rotational position by the driving device, thereby the game medium is straddled to the game medium paying out part through the first guide path, the outer wall of the tubular guiding part and third guide path, the game medium inserted from the game medium insertion part can be surely guided to the game medium accumulating part or to the game medium paying out part by simple action of only rotating the straddling member through the driving device between the first rotational position and the second rotational position.

And the straddling device is constructed from the rotatable straddling member and the driving device for rotating the straddling member, thus structure of the straddling device can be simply constructed.

Further, since the number of parts for constructing the straddling device can be reduced, it can realize the low-cost straddling device, and the straddling device scarcely gets out of order, maintenance of the straddling device can be easily conducted.

Furthermore, when the straddling member is retained to the first rotational position, the game medium can be guided to the game medium accumulating part through the first guide path, the tubular guiding part and the second guide path, and when the straddling member is retained to the second rotational position, the game medium can be guided to the game medium paying out part through the first guide path, the outer wall of the tubular guiding part and the third guide path, thereby it can prevent the game medium from jumping up and down. As a result, it can omit sensors for detecting places where the game medium is to be sent, differently from prior gaming machines.

In particular, in a case that the game medium is sent to the game medium accumulating part, the tubular guiding part in the straddling member retained to the first rotational position opposes to the opening of the second guide path and closes the opening of the third guide path, therefore the game medium is straddled to the game medium accumulating part through a duct c nstructed from inner walls of th tubular guiding part in the straddling member and the second guide path. As a result, it can surely prevent false straddling such that the game medium is falsely sent to the game medium paying out part due to jumping up and down thereof.

And in a case that the game medium is sent to the game medium paying out part, the tubular guiding part in the straddling member retained to the second rotational position closes the opening of the second guide path, therefore the game medium is straddled to the game medium paying out part through the outer wall of the tubular guiding part and the third guide path. As a result, it can surely prevent false straddling such that the game medium is falsely sent to the game medium accumulating part due to jumping up and down thereof.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated herein and constitute a part of this specification illustrate embodiments of the invention and, together with the description, serve to explain the objects, advantages and principles of the invention.

In the drawings, FIG. 1 is a front view of a slot machine according to the embodiment of the present invention,

FIG. 2 is a perspective exploded view of a d or and a frame in the slot machine according to the embodiment of the present invention,

FIG. 3 is a perspective exploded view of a coin straddling device in the slot machine according to the embodiment of the present invention,

FIG. 4 is a perspective view of circumference construction around the coin straddling device in the slot machine according to the embodiment of the present invention,

FIG. 5 is an explanation view indicating a state that the door in the slot machine is opened, according to embodiment of the present invention,

FIG. 6 is an explanation view partially indicating the straddling device that a straddling member is in a first state, according to the embodiment of the present invention, and

FIG. 7 is an explanation view partially indicating the straddling device that a straddling member is in a second state, according to the embodiment of the present invention.

### DETAILED DESCRIPTION OF THE PREFERRED EMBODIMENTS

A gaming machine will be described with reference to drawings according to the embodiment embodying the present invention.

Hereinafter, though it will be described according to the embodiment that the present invention is embodied in a slot machine, it is, of course, apparent that the present invention can be embodied in various gaming machines in which games are done using metal game media such as coins, medals and the like. The gaming machines may include various gaming machines such as a video gaming machine, a card gaming machine and the like.

The slot machine of the embodiment will be described with reference to FIG. 1.

FIG. 1 is a front view of the slot machine. The slot machine has a cabinet 2 at the front of which a door 3 is arranged so as to be able to open and close. And a top frame 4 is arranged at an upper position of the cabinet 2. In front of the top frame 4, a decoration panel 41 is positioned.

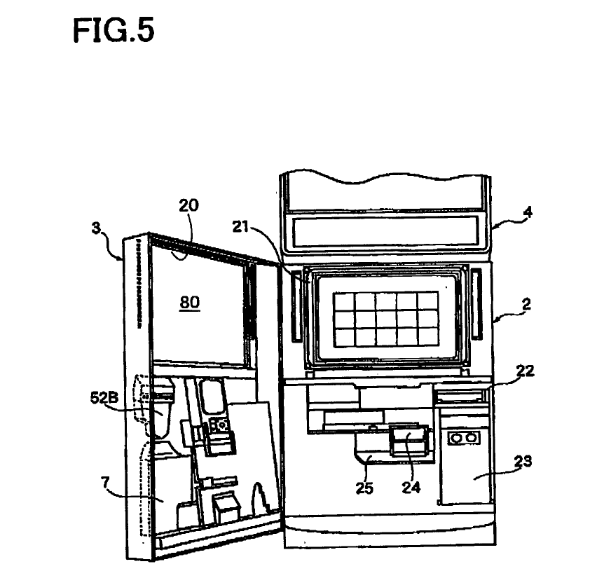

An image display device 21, on which game information is displayed, is positioned in the cabinet 2. Further, at an upper part of the door 3, a rectangular opening 20 is formed so that images displayed on the image display device 21 can be seen from the outside of the slot machine 1. A clear plate 80 (see FIG. 5) is arranged in the rectangular opening 20 so as to be able to see images displayed on the image display device 21 through the rectangular opening 20 and protect the display surface of the image display device 21. At both sides of the rectangular opening 20, speaker grills 902L, 902R are formed so that players can easily hear sounds or music produced based on game conditions.

At front central part of the door 3, an operation part 5 is positioned, the operation part 5 being forwardly projected. And on a left inclined surface of the operation part 5, various operation buttons are arranged and a coin insertion slot 51 is formed. On a right side of the operation part 5, a bill insertion part 52 in which a bill guide plate 52A is arranged, is formed. The bill insertion part 52 guides bills inserted therethrough to a bill validator 22 (shown in FIG. 5) installed in the cabinet 2.

At a lower position of a pedestal forming the operation part 5, a display window 800 is formed. Through the display window 800, various numerals displayed on display parts of plural counters while being changed according to game conditions can be seen. Thereby, manag rs of the game arcade can directly confirm out of the slot machine 1 the numerals displayed by the counters installed in the cabinet 2, without opening the door 3. The display window 800, of course, may be arranged at various positions such as a side of the slot machine 1, a lower position of the decoration panel 41 and a lower end of the slot machine 1.

A frame 6, which is connected to the door 3 so as to be able to open and close against the door 3, is arranged at a lower part of the operation part 5. A decoration panel 61 made of rectangular transparent glass plate or transparent synthetic resin plate with light transmitting ability is installed in the frame 6. At a bottom part of the door 3 corresponding to a lower part of the frame 6, a coin tray 30 accumulating paid out coins is arranged.

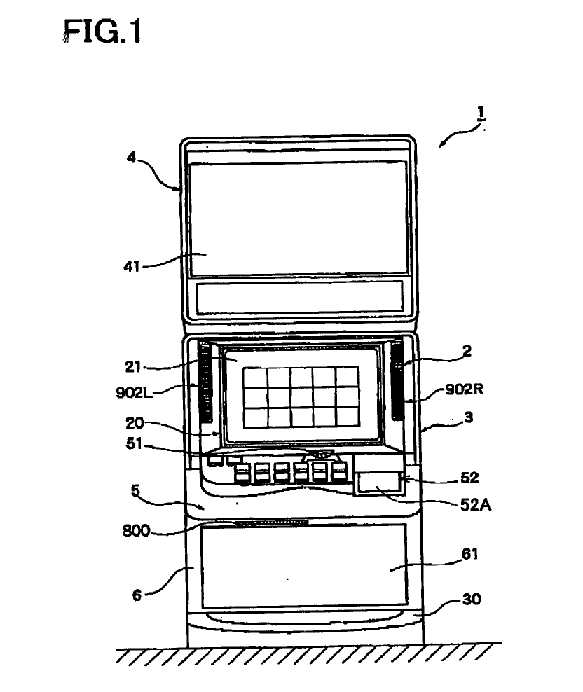

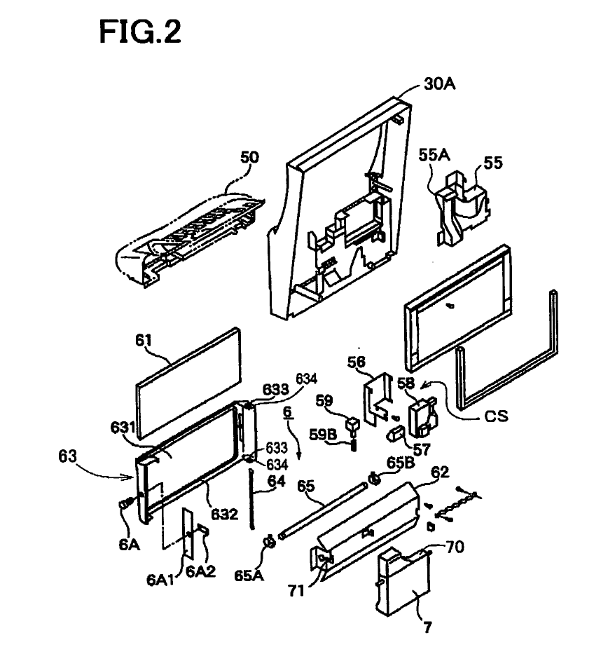

Hereinafter, the frame 6 will be described with reference to FIG. 2. FIG. 2 is a perspective exploded view of the door 3 and the frame 6.

In FIG. 2, a frame plate 63 is formed in a frame-like shape so as to hold a window 631. The frame plate 63 is made of light metal material or light hard synthetic resin material and formed into one-piece construction. A decoration panel plate 61 is set in the frame plate 63. At a front part of the frame plate 63, the window 631 is opened so that decoration on the decoration panel plate 61 can be seen when the decoration panel plate 61 is set in the frame plate 63. And a receiving part 632 is formed so as to extend from the bottom part of the frame plate 63. The receiving part 632 supports the lower end edge of the decoration panel plate 61 and prevents the plate 61 from dropping downward.

At the l ft side of the frame plate 63, a plate 6A1 for fixing a cylind r lock 6A to the frame plate 63 is installed. A stop plate 6A2 for locking the frame 6 to the door 3 is connected to the right and of the rotation shaft of the cylinder lock 6A. At upper right and lower left positions of the frame plate 63, support plates 634 are formed and a through hole 633 is formed in each of the support plates 634. In these through holes 633, a support shaft 64 is inserted, both upper and lower ends of the support shaft 64 being rotatably supported in the door 3. Thereby, the frame plate 63 is rotatably connected to the door 3 through the support shaft 64.

Further, a cover 62 is positioned at the backside of the frame plate 63 and a pair of sockets 65A and 65B are installed inside of the cover 62. Both ends of a fluorescent tube 65 are connected and supported to the sockets 65A and 65B.

Here, in a state that the decoration panel plate 61 is removed from the frame plate 63, the fluorescent tube 65 can be easily exchanged since the window 631 formed in the frame plate 63 is comparatively wide. And the cover 62 is made of silver metal material, therefore the cover 62 reflects light scattered from the backside of the fluorescent tube 65 toward the decoration panel plate 61. As a result, the cover 62 can brightly light up the decoration panel plate 61 from the backside thereof.

A drain bottle 7 is installed at the rear side of the cover 62, the drain bottle 7 accumulating liquid such as beverage and the like without flowing into a hopper 25 (see FIG. 5) in a case that liquid flows into the cabinet 2 from the bill insertion part 52. On an upper surface of the drain bottle 7, an opening 70 is formed and a drain storage part continuous downward from the opening 70 is formed into a long sideways and thin shape. The thus constructed drain bottle 7 is installed along the rear side of the cover 62 on the basis of the long sideways shape thereof.

Here, the drain bottle 7 is made of transparent or semitransparent material (for example, glass or synthetic resin) so as to visually confirm liquid quantity stored in the drain bottle 7 from outside thereof. And storage ability of the drain bottle 7 is set to about one litter.

Hereinafter, construction of the coin straddling device will be described according to FIG. 2. In FIG. 2, the coin insertion slot 51 (see FIG. 1) is arranged in a control panel 50 of the operation part 5. And a coin guide member 55 with a first coin guide path 55A is installed at the rear side of a front frame 30A. The coin inserted from the coin insertion slot 51 is guided to a coin straddling member 57 in a coin straddling device CS through the first coin guide path 55A of the coin guide member 55.

Further, at the rear side of the front frame 30A, a retaining bracket 56 is installed. The retaining bracket 56 retains the coin straddling member 57 rotatably. A detecting device 58 is positioned to the retaining bracket 56. The detecting device 58 detects whether the coin inserted from the coin insertion slot 51 and guided to the first coin guide path 55A is true or not and detects passage of the coin, thereafter transmits coin truth detection signal and coin passage signal to the control part of the slot machine 1.

At the left side of the retaining bracket 56, a magnetic solenoid 59 is fixed. When the solenoid 59 is magnetized, a compressing coil spring 59B is compressedly wound around a rod 59A attracted to the magnetic solenoid 59.

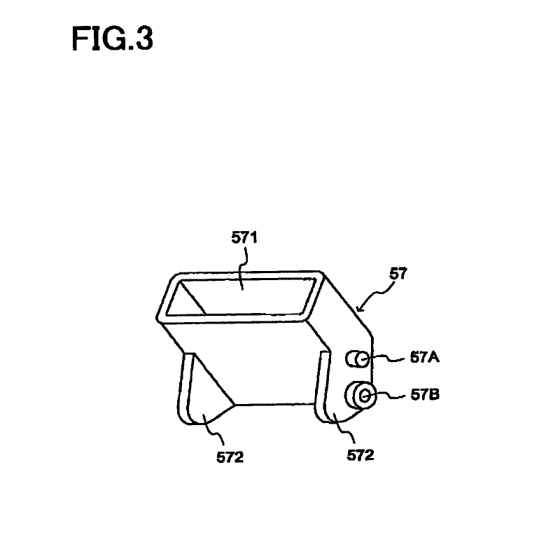

The coin straddling member 57 will be described with reference to FIG. 3, hereinafter. FIG. 3 is a perspective view of the coin straddling member 57. As shown in FIG. 3, the coin straddling member 57 has a tubular guiding part 571 and a pair of brackets 572 which are projected along both side walls of the tubular part 571 like a sword guard. Both brackets 572 act as support parts for rotatably supporting the coin straddling member 57. Further, on the both side walls of the tubular part 571, a pair of cylindrical projections 57A (one of them is shown in FIG. 3) are projected outward, axis centers of the cylindrical projections 57A coincides with each other at both side walls of the tubular part 571. And on one of the brackets 572 (the bracket 572 on the right side wall in FIG. 3), a through hole 57B is formed.

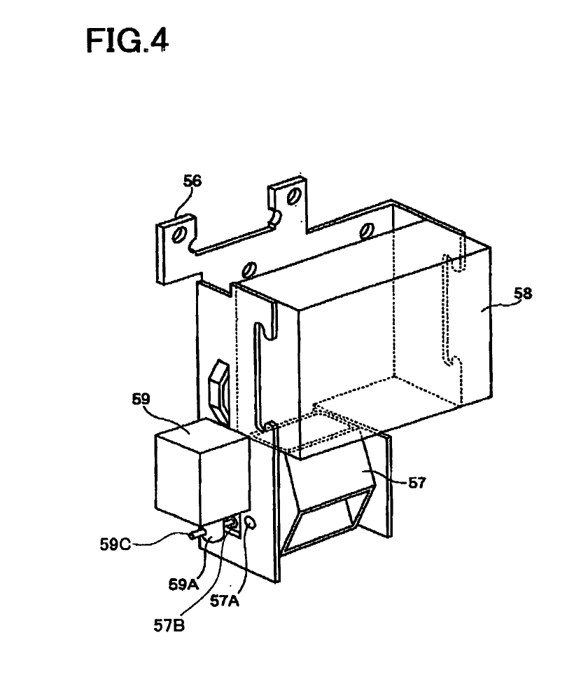

A circumference construction around the coin straddling device CS will be described with reference to FIG. 4. FIG. 4 is a perspective view of the circumference construction of the coin straddling device CS. In FIG. 4, the coin straddling member 57 in the coin straddling device CS is supported to the retaining bracket 56 by the cylindrical projections 57A. That is to say, the coin straddling member 57 is rotatably supported to the retaining bracket 56 by the cylindrical projections 57A. As mentioned, based on that the cylindrical projections 57A formed in the coin straddling member 57 are supported to the retaining bracket 56, thereby the coin straddling member 57 is rotatably supported to the retaining bracket 56, parts for constructing the coin straddling device CS can be reduced, thereby cost thereof can be reduced.

Further, at the top end (lower end) of the rod 59A in the magnetic solenoid 59, a pin 59C is compressedly inserted. This pin 59C is rotatably connected to the through hole 57B formed on the bracket 572.

Here, FIG. 4 shows a state that the magnetic solenoid 59 is not magnetized. when the magnetic solenoid 59 is magnetized from the state shown in FIG. 4, the rod 59A is attracted (the rod is raised upward) and the coin straddling member 57 is rotated to a first direction (clockwise direction, mentioned later) around the axis centers of the cylindrical projections 57A (the axis centers become rotation fulcrum). And when magnetization of the solenoid 59 ceases, the rod 59A moves downward by urging force of the coil spring 593, thereby the coin straddling member 57 is rotated to a second direction reverse to the first direction (anti-clockwise direction, mentioned later) around the axis centers of the cylindrical projections 57A. As a result, the coin straddling member 57 returns in the state shown in FIG. 4.

In FIG. 5, it is indicated a state that the door 3 is opened. A coin guide 24 is arranged in the cabinet 2. The coins (true coins) straddled by the coin straddling member 57 of the coin straddling device CS flows into the coin guide 24. The coins guided in the coin guide 24 move into a bucket (not shown). And the coins in the bucket are accumulated in the hopper 25 (see FIG. 5).

As shown in FIG. 5, the bill validator 22 and a bill stacker 23 are arranged in the cabinet 2. The bill validator 22 validates whether bills inserted along the bill guide plate 52A (see FIG. 1) in the bill insertion part 52 are true or not, or good or not. The bill stacker 23 stores bills validated true by the bill validator 22. As mentioned, bills inserted from the bill insertion part 52 along the bill guide plate 52A into the cabinet 2 are inserted in the bill receiving opening of the bill validator 22, thereafter stored in the bill stacker 23.

The above mentioned bill insertion part 52 is constructed from the bill guide plate 52A and an installing member 52B. And both the bill guide plate 52A and the installing member 52B are integrally installed to the operation part 5. The hopper 25 accumulates coins straddled by the coin straddling member 57 in the coin straddling device CS after inserted from the coin insertion slot 51.

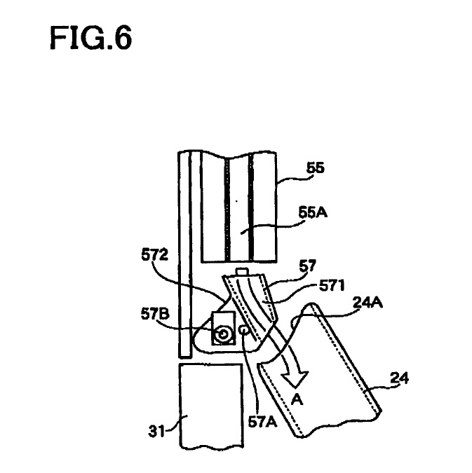

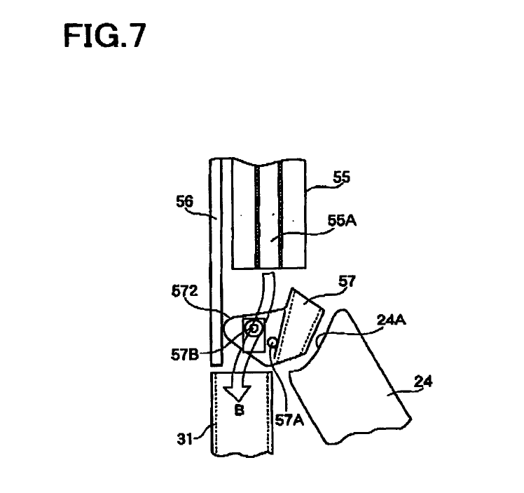

Movement and effects of the coin straddling device CS will be explained with reference to FIGS. 6 and 7, hereinafter. FIG. 6 is an explanation view partially indicating the coin straddling device that the straddling member 57 is in a first state. In the state shown in FIG. 6, the magnetic solenoid 59 is not magnetized and the slot machine 1 is in a state that credit function is effective and coins can be counted. In other words, the slot machine 1 is in a state that true coins inserted through the coin insertion slot 51 and detected by the detecting device 58 can be guided to the hopper 25 up to a predetermined number.

In FIG. 6, coins inserted through the coin insertion slot 51 are guided downward by free fall thereof to the coin straddling member 57 through the first coin guide path 55A. Further, coins are guided by free fall in a duct constructed by inner walls of the tubular part 571 and inserted in an opening 24A of the coin guide 24. In this state, as shown in FIG. 6, the upper opening of the tubular guiding part 571 and the lower opening of the first coin guide path 55A oppose with each other. Therefore, the coin straddling member 57 closes the upper opening of th third coin guide path which is constructed by outer walls of the tubular part 571, inner walls of the bracket 572 and inner wall of the retaining bracket 56. Here, lateral cross section of the tubular guiding part 571 is substantially rectangle and inner walls of the tubular guiding part 571 become a part of the second coin guide path. Namely, coins are guided to a direction indicated by an arrow A in FIG. 6.

FIG. 7 is an explanation view partially indicating the coin straddling device CS that the coin straddling member 57 is in a second state. In the state shown in FIG. 7. the magnetic solenoid 59 is magnetized. In other words, FIG. 7 shows one state that when the detecting device 58 detects that coins inserted through the coin insertion slot 51 are not true, the magnetic solenoid 59 is magnetized by the control part of the slot machine 1. And FIG. 7 also shows another state that when the control part of the slot machine 1 counts coins more than the predetermined number of coins inserted through the coin insertion slot 51, coins excess of the predetermined number are paid out to the coin tray 30.

In FIG. 7, coins inserted through the coin insertion slot 51 are guided downward by free fall to the coin straddling member 57 through the first coin guide path 55A. Here, in the state shown in FIG. 7, the tubular guiding part 571 is rotated in a state that the tubular guiding part 571 closes the opening 24A of the coin guide 24, the opening constructing the second coin guide path.

Thus, coins are guided to the third coin guide path. Here, the outer wall of the tubular guiding part 571 opposite to the inner wall of the retaining bracket 56, inner walls of the brackets 572 mutually opposing and the inner wall of the retaining bracket 56 construct a part of the third coin guide path. And coins guided by free fall thereof through the third coin guide path are introduced in an upper opening of the coin guide 31 Further, coins are continuously guided to the coin tray 30 through the coin guide 31. That is to say, coins are guided to a direction indicated by an arrow B in FIG. 7.

In FIG. 6, when an outlet of the first coin guide path 55A and an inlet of the tubular guiding part 571 of the coin straddling member 57 constructing a part of the second coin guide path coincide with each other, the coin straddling member 57 is retained in the unmovable state. Contrarily, in FIG. 7, the outlet of the first coin guide path 55A and an inlet of the third coin guide path constructed by the outer wall of the tubular guiding part 571, the inner walls of the bracket 572 and the inner wall of the retaining bracket 56 coincide with each other, the coin straddling member 57 is retained in the unmovable state. As mentioned, the coin straddling member 57 in the coin straddling device CS can rotate around the cylindrical projections 57A acting for rotational center within a predetermined angular range. This can express in other way that the coin straddling member 57 is rotatable within a predetermined stroke range of the rod 59A in the magnetic solenoid 59.

Further, as shown in FIGS. 6 and 7, the rotational shaft (axis center of the cylindrical projections 57A) of the coin straddling member 57 is positioned at the substantially right under position which corresponds to the fall position of coins falling from the first coin guide path 55A.

Based on the above construction, falling energy of coins, that is, collision force of coins acting to inner and outer walls of the coin straddling member 57 substantially concentrate to the rotational shaft (the cylindrical projections 57A). Therefore, it can prevent the coin straddling member 57 from being rotated from the stop state due to the collision force of coins. As a result, it can prevent the coin straddling member 57 from being falsely moved (rotated).

And since the coin straddling member 57 is made of light hard synthetic resin and is formed in one-piece construction, inertia force of the coin straddling member 57 can be reduced while rotating. Thereby, time necessary for rotating the coin straddling member 57 and changing rotational position thereof between the state shown in FIG. 6 and the state shown in FIG. 7 can be reduced (shortened). Namely, waiting time necessary for changing rotational state of the coin straddling member 57 can be reduced. In addition, since the coin straddling member 57 is formed in one-piece construction, the number of parts thereof can be rather reduced, thus, cost of the coin straddling member 57 can also be reduced. And since the number of parts of the coin straddling member 57 is reduced and the coin straddling member 57 is less likely to get out of order, the coin straddling member 57 can be easily maintained.

In FIG. 6, the start opening of the second coin guide path (the upper opening of the tubular guiding part 571 in the coin straddling member 57) is opened so as to guide coins from the first coin guide path 55A. And the opening 24A of the coin guide 24 is opened so as to guide coins from the second coin guide path (the lower opening of the tubular guiding part 571 in the coin straddling member 57). Similarly, in FIG. 7, the start opening of the third coin guide path (the upper opening of the path c nstructed by the outer wall of the tubular guiding part 571, the inner walls of the brackets 572 and the inner wall of the retaining bracket 56) is opened so as to guide coins from the first coin guide path 55A. And the opening of the coin guide 31 is opened so as to guide coins from the third coin guide path (the lower opening of the path constructed by the outer wall of the tubular guiding part 571, the inner walls of the brackets 572 and the inner wall of the retaining bracket 56).

As constructed according to the above, coins scarcely jumps up and down, thereby coin straddling action by the coin straddling member 57 can be surely conducted. Therefore, it can omit sensors for detecting places where coins are to be sent in the slot machine 1, differently from the prior slot machines.

What is claimed is:

1. A gaming machine including:
a game medium insertion part through which a game medium is inserted in a cabinet, the game medium insertion part being provided in the cabinet;
a game medium accumulating part for accumulating the game medium inserted from the game medium insertion part in the cabinet; and
a straddling device for straddling the game medium inserted from the game medium insertion part to one of the game medium accumulating part and a game medium paying out part;
wherein the straddling device includes;
a straddling member rotatably supported in the cabinet, the straddling member having a first guiding part through which the game medium is guided to the game medium accumulating part and a second guiding part through which the game medium is guided to the game medium paying out part; and
a driving device for rotating the straddling member;
wherein the straddling member straddles the game medium to the game medium accumulating part through the first guiding part or to the game medium paying out part through the second guiding part, according to rotational state of the straddling member rotated by the driving device.

2. The gaming machine according to claim 1, wherein the driving device rotates the straddling member between a first rotational position and a second rotational position,
wherein the straddling member straddles the game medium to the game medium accumulating part through the first guiding part while retained in the first rotational position by the driving device; and
wherein the straddling member straddles the game medium to the game medium paying out part through the second guiding part while retained in the second rotational position by the driving device.

3. The gaming machine according to claim 2, wherein the gaming machine comprises:
a first guide path for guiding the game medium inserted from the game medium insertion part to the straddling device;
a second guide path for guiding the game medium to the game medium accumulating part from the straddling device; and
a third guide path for guiding the game medium to the game medium paying out part from the straddling device.

4. The gaming machine according to claim 3, further comprising:
a door arranged in front of the cabinet so as to be able to open and close;
a frame arranged at a rear side of the door; and
a game medium guide member arranged in the frame;
wherein the first guide path is formed in the game medium guide member.

5. The gaming machine according to claim 3, wherein the first guiding part formed in the straddling member comprises a part of the second guide path when the straddling member is retained to the first rotational position.

6. The gaming machine according to claim 3, wherein the second guiding part formed in the straddling member comprises a part of the third guide path when the straddling member is retained to the second rotational position.

7. The gaming machine according to claim 5, wherein the first guiding part of the straddling member is constructed of a tubular guiding part formed in the straddling member.

8. The gaming machine according to claim 7, where in the tubular guiding part of the straddling member closes an opening of the third guide path when the straddling member is retained to the first rotational position.

9. The gaming machine according to claim 7, where in the tubular guiding part of the straddling member closes an opening of the second guide path when the straddling member is retained to the second rotational position.

10. The gaming machine according to claim 4, further comprising
a retaining member installed adjacent to the game medium guide member in the frame;
support shafts formed on both side walls of the straddling member so as to outwardly project from the side walls, the support shafts being rotatably supported in the retaining member;
wherein the straddling member is rotatably supported in the retaining member by the support shafts.

11. The gaming machine according to claim 10, further comprising:
extension parts each of which is extended from the side wall of the straddling member;
connecting hole formed in the extension part;
a magnetic solenoid with a movable rod, the magnetic solenoid being installed in the retaining member; and
a connecting shaft for connecting an end of the movable rod and the connecting hole;
wherein the straddling member is rotated around the support shafts by moving the movable rod to magnetize the magnetic solenoid.

12. The gaming machine according to claim 10, wherein the support shafts are positioned at a substantially right under position of a fall position of the game medium falling from the first guide path after guided thereby.

13. The gaming machine according to claim 10, further comprising:
a detecting device for detecting whether the game medium is true or not, the detecting device being installed in the retaining member;
wherein the straddling member is retained to the first rotational position by the driving device when the detecting device detects that the game medium is true, and
wherein the straddling member is retained to the second rotational position by the driving device when the detecting device detects that the game medium is not true.

14. The gaming machine according to claim 1, wherein the straddling member is made of light hard synthetic resin material and is f rmed into one-piece c nstruction.

15. A gaming machine including;
a game medium insertion part through which a game medium is inserted in a cabinet, the game medium insertion part being provided in the cabinet;
a game medium accumulating part for accumulating the game medium inserted from the game medium insertion part in the cabinet;
a straddling device for straddling the game medium inserted from the game medium insertion part to one of the game medium accumulating part and a game medium paying out part;
a first guide path for guiding the game medium inserted from the game medium insertion part to the straddling device;
a second guide path for guiding the game medium to the game medium accumulating part from the straddling device; and
a third guide path for guiding the game medium to the game medium paying out part from the straddling device;
wherein the straddling device includes;
a straddling member rotatably supported in the cabinet, the straddling member having a tubular guiding part for guiding the game medium to the game medium accumulating part; and
a driving device for rotating the straddling member;
wherein the driving device rotates the straddling member between a first rotational position and a second rotational position,
wherein the tubular guiding part of the straddling member opposes to an opening of the second guide path and closes an opening of the third guide path while the straddling member is retained to the first rotational position by the driving device, thereby the game medium is straddled to the game medium accumulating part through the first guide path, the tubular guiding part and the second guide path, and
wherein the tubular guiding part of the straddling member closes the opening of the second guide path while the straddling member is retained to the second rotational position by the driving device, thereby the game medium is straddled to the game medium paying out part through the first guide path, an outer wall of the tubular guiding part and the third guide path.
